(19) United States
(12) Patent Application Publication
(10) Pub. No.: US 2010/0259011 A1
(43) Pub. Date: Oct. 14, 2010

(54) SEAL RING OF A MECHANICAL SEAL ASSEMBLY

(76) Inventors: Joachim Otschik, Aschaffenburg (DE); Andreas Schrüfer, Wolfratshausen (DE); Rudolf Schicktanz, Geretsried (DE); Martin Kirchhof, Munchen (DE)

Correspondence Address: EDWARDS ANGELL PALMER & DODGE LLP, P.O. BOX 55874, BOSTON, MA, 02205, US

(21) Appl. No.: 12/734,679

(22) PCT Filed: Oct. 22, 2008
(86) PCT No.: PCT/EP2008/008937

§ 371 Date: Jun. 22, 2010

(30) Foreign Application Priority Data
Dec. 4, 2007 (DE) 20 2007 016 868.3

(51) Int. Cl. F16J 15/00; F16J 15/16

(52) U.S. Cl. 277/345

(57) ABSTRACT

The invention relates to a seal ring of a mechanical seal assembly, comprising a base body made of a material including at least one carbide material and a coating provided at the base body and creating a sliding surface, said coating consisting of a diamond material. The inventions is characterized in that the base body is formed of a two-component material by embedding particulate regions made of a diamond material compatible with the diamond material of the coating into the material comprising at least one carbide.

The invention relates to a seal ring of a seal ring assembly of the type mentioned in the preamble of claim 1.

From DE 20 2006 006 525 U, a seal ring of a seal ring assembly is already known, the base body of which is formed of a SiC material, wherein a face side of the base body is covered by a layer made of a diamond material. The document further discloses that diamond coatings can be applied directly onto the respective face side in situ by a so-called CVD-deposition method (hot filament chemical vapour deposition method). During this process, the base body is subjected to high thermal stress. Three-dimensional bodies, which may be seal rings, made of ceramic materials such as SiC having fine crystalline diamond coatings are further known from DE 199 22 665 A. The document further discloses detailed information concerning the CVD deposition method and the parameters related thereto.

The known seal rings of the aforementioned kind have in common that the diamond coatings in fact feature a natural high strength against thermally induced stress and may therefore be exposed to high temperatures and rapid temperature changes as well as simultaneously to high mechanical stress during operation offhand, without the occurrence of internal breaks or fissures in the diamond coating. However, in practice, it has proven that the carbide material, in particular SiC, of the base body reacts much more sensitively under such operating conditions. Therefore, fissures and breaks may occur in the base body under the diamond coating, thus not only more or less destroying the inner cohesion of the base body, but also local occurrence of dissolution between the base body and the diamond coating may be possible. Despite the diamond coatings being still intact per se, the occurrence of fissures or breaks in the base body requires an immediate replacement of the seal rings. On the other hand, these are generally very expensive components.

In view of the problems in connection with the known diamond-coated base bodies made of a carbide material, it is an object of the invention to provide a seal ring of the generic type, which offers an enhanced operational reliability at high temperatures, in particular rapidly changing temperatures, and/or mechanical stress.

This object is solved by the features of claim 1.

According to the invention, the base body, contrary to the known seal ring assemblies, consists of a two-component material. This material comprises a carbide material such as SiC or WC, possibly together with incorporated Si or Ni parts between the individual carbide grains, and particulate portions or grains made of a suitable diamond material distributed on the cross-section of the base body. Preferably, this diamond material corresponds to that forming the coating. It may also differ therefrom, provided that a chemical-physical-structural compatibility between the diamond materials exists. It was found out that the diamond particles or grains should assume a volume fraction of 10 to 90% in the base body.

The inventive two-component base body stands out due to its considerably enhanced strength against fissure and break under internal tension caused by thermal or mechanical stress. In particular, the connection between the diamond material of the coating and the base body has proven to be much more stable, since the diamond coating is securely anchored at the diamond grains of the base body. In addition, the fact that the diamond material has a substantially higher heat conductivity compared to SiC or WC results in a promotion of the dissipation of heat to the environment, such that internal hot spot zones either do not occur or can be degraded in short time. A further advantage of providing a base body made of the two-component material is an increased abrasion resistance at the surface regions of the base body, which are not protected against abrasion by the diamond coating.

The diamond material particles in the base body should have a grain size in the range of 0.01 to 1.0 mm, wherein a grain size of 0.02 to 0.2 mm is preferred. In general, the diamond material particles have an irregular spatial outline configuration. The term “grain size” therefore refers to the dimension at that location of an irregular grain, at which a maximum diametrical dimension exists. The distribution of the diamond particles in the base body may be regular or, if desired, irregular, e.g. by having an increased concentration of diamond particles at cross-sectional regions near the diamond coating.

As already mentioned, the proportion of the diamond material in the two-component material should range between 10 and 90% by volume. Preferably, the proportion ranges between 40 and 70% by volume, wherein a proportion of 50 to 60% by volume is particularly preferred. It was also already mentioned that the silicon fraction in the base body can be formed predominantly by SiC (silicon carbide), but may also comprise SiC in combination with Si (silicon). In case of WC (tungsten carbide) as the carbide material, this may be present in pure form, but also with a fraction of e.g. 6% by volume of Ni (nickel) added.

A preferred method for producing the inventive two-component base body includes mixing the carbide material and the diamond material, both provided in the form of loose particles, and subsequently forming a strong composite by sintering. Suitable sintering methods are known to the skilled person, such that no detailed explanations are required in this context.

After forming the two-component base body, the diamond coating can be applied on the body in situ by a suitable diamond deposition method. The free surface of the diamond coating provides a sliding or sealing surface with high friction wear and further features a high thermal, mechanical and chemical strength. Preferably, so-called hot filament CVD or plasma CVD methods are used. These methods including all relevant processing parameters and conditions to be observed are known to the skilled person and therefore do not have to be explained in detail herein. Basic principles of the hot filament CVD method are e.g. disclosed in Busmann, H-G., Hertel, I. V., Vapor Grown Polycrystalline Diamond Films, Carbon 36(4), 1998. Processing directions concerning the hot filament CVD method are further included in DE 199 22 665 B4 already mentioned at the beginning. Concerning the plasma CVD method, reference can be made e.g. to Jones, G. A., On the behavior of mechanical seal face materials in dry line contact, Wear 256(3-4), 2004.

Seal rings provided according to the invention are preferably used in mechanical seal assemblies which are exposed to high temperatures and pressures during operation. Preferably, both seal rings of a co-operating pair may be formed in the inventive manner, or only one thereof, whereas the other seal ring may consist of a different, suitable material. The general structure of a mechanical seal assembly is known to the skilled person and does not require any detailed explanation.

1. A seal ring of a mechanical seal assembly, comprising:
a base body made of a material including at least one carbide material, and
a coating provided at the base body and creating a sliding surface, said coating consisting of a diamond material, wherein the base body is formed of a two-component material by embedding particulate regions made of a diamond material compatible with the diamond material of the coating into the material comprising at least one carbide material.

2. The seal ring of claim 1, wherein the diamond materials for the coating and the base body are either identical or different.

3. The seal ring of claim 1, wherein the particulate regions made of diamond material have a grain size in the range of 0.01 to 1.0 mm, preferable 0.02 to 0.2 mm.

4. The seal ring of claim 1, wherein the proportion of the diamond material in the two-component material ranges between 10 to 90% by volume, preferably between 40 to 70% by volume, most preferably between 50 to 60% by volume.

5. The seal ring of claim 1, wherein the base body is formed by sintering particulate carbide material and diamond material.

6. The seal ring of claim 1, wherein the carbide material is one of the group of materials comprising SiC and WC.
